(19) United States
(12) Patent Application Publication
(10) Pub. No.: US 2019/0244535 A1
(43) Pub. Date: Aug. 8, 2019

(54) CARD-BASED SYSTEM FOR TRAINING AND CERTIFYING MEMBERS IN AN ORGANIZATION

(71) Applicant: Mercury Studio LLC, Royal Oak, MI (US)

(72) Inventors: Zachary W. Ball, Troy, MI (US); Joshua L. Ball, Waterford, MI (US)

(21) Appl. No.: 15/889,831

(22) Filed: Feb. 6, 2018

(51) Int. Cl. G09B 7/08; G09B 7/06; G09B 5/06; G09B 5/12; G06N 99/00; G06F 17/21; G06F 3/0482

(52) U.S. Cl. CPC G09B 7/08; G09B 7/066; G09B 5/065; G06F 3/0482; G06N 99/005; G06F 17/211; G09B 5/125

(57) ABSTRACT

A method of certifying members in an organization using a card-based system. The method includes the steps of providing a plurality of cards to a member. Each of the cards includes content provided by the organization. There is also at least one card deck comprising the cards which are associated with a specific topic, such as a job skill. The cards can have content associated with the specific topic, and at least one of the cards includes a question about the specific topic. The card deck is dispensed to a member in the organization, and the member attempts to learn the content on the cards in the card deck. Cards bearing questions are presented to the member, and the member attempts to answer the questions. The member can then be certified as being proficient in the specific topic if the member answers the questions correctly.

### BACKGROUND OF THE INVENTION

### 1. Field of the Invention

The present invention pertains to a card-based system for organizing and presenting information to a user. More particularly, the present invention pertains to a card-based system for organizing and presenting information to a user which has an electronic user interface, and the content and organization of the information is highly customizable.

### 2. Description of the Prior Art

Card-based learning systems are well-known in the prior art. One such example of a card-based learning system is known as flashcards. Flashcards typically have content or a question on the front face of the card, and an answer on the back face of the card. Flashcards are an excellent learning tool for people of all ages. However, one particular use for flashcards is in a schoolroom environment to teach children facts about schoolroom subjects, such as multiplication tables, or facts pertaining to history, science, or the like.

This type of card-based learning system is suitable for its intended purpose, and accordingly has been used for many years. In addition, customized flashcards can be made easily using index cards.

However, there are inherent drawbacks to this physical set of cards. Using the classroom setting as an example, the teacher is unable to quickly and easily monitor each student's progress with learning the content on the flashcards. Separate testing apart from the flashcards must be used to assess the students' proficiency in the content on the cards. Thus, traditional flashcards provide a physical system which is well-suited for studying or learning, but is not particularly advantageous for testing. In addition, it is difficult for the teacher to monitor each student's progress closely to ensure that each student does not sit idle after mastering a set of material. Likewise, it may also be difficult for a teacher to recognize when a student needs additional attention until after a test has already been administered, and much of the class has moved on to new material.

Thus, there is a need for a card-based learning system which utilizes the existing advantages from physical card-based systems in the prior art, but which adds the ability to provide instant feedback on the progress and proficiency of each student (or user), allows new material (or content) to be provided to each user once the user has mastered the current set of material, and also provides real-time ability to modify and reorganize the material as needed. The present invention, as is detailed hereinbelow, seeks to address these shortcomings in the prior art, as well as other shortcomings.

### SUMMARY OF THE INVENTION

The disclosed embodiments relate to a computing device with an improved user interface for applications. The term “computing device” refers to any kind of device which can process and display information. The aspects of the disclosed embodiments have specific application to mobile telephones. The term “mobile telephone” refers to any kind of a mobile device with telecommunications capabilities and includes radio (a mobile) telephones, smart phones, communicators, PDAs, and wireless information devices. It includes devices able to communicate using not only mobile radio such as GSM or UMTS, but also any other kind of wireless communications system, such as Bluetooth. Preferably the computing device comprises a non-transitory computer-readable storage medium having computer-readable code embodied in the medium which, when running on a computing device, causes the computing device to display on a screen of the device following graphical interface features described below.

According to a first embodiment of the present invention, there is provided a computing device comprising a display screen, the computing device being able to display on the screen a card-based system for organizing and presenting content comprising:

(1) a plurality of cards, each card having a front face and a rear face, and the cards including user-provided content on at least the front face thereof, the cards further being configured to be flipped to selectively display the front face or the rear face;

(2) at least one card deck, the card deck comprising at least one of the cards;

(3) at least one computer-selected tag being associated with the content on the cards, the computer-selected tag being chosen by a software program having artificial intelligence; and

(4) wherein the content is of the type selected from the group consisting of text, an image, a hyperlink, a video, an audio recording, or an Internet webpage.

Preferably, the rear face also includes user-provided content. And even more preferably, the user-provided content on the rear face is relevant to the user-provided content on the front face.

Optionally, the user-provided content on the front face is a summary of the user-provided content on the rear face.

Optionally, each of the cards is capable of simultaneously being in one or more card deck. Furthermore, the cards are optionally capable of being added to any provided card deck by a user.

Optionally, the front face and/or the rear face of the card includes a web browser for viewing Internet content.

There is also provided a method of selecting the computer-selected tag in the card-based system described above. This method includes the steps of: manually reviewing the computer-selected tag by a user; and manually overwriting the computer-selected tag with a corrected tag by the user when the computer-selected tag is incorrect.

Optionally, this method also includes the steps of analyzing the computer-selected tag and the corrected tag by the software program having artificial intelligence; and learning, by the software program having artificial intelligence, how to select tags more accurately in the future based on the manually-applied corrected tags.

According to a second embodiment of the present invention, there is provided a method of training (or teaching) and certifying members in an organization using a card-based system, the method including the steps of:

(1) providing a member with a computing device operating a computer program, the computing device comprising a display screen, the computing device being configured to display on the screen a plurality of cards, each card having a front face and a rear face, the cards including content provided by the organization, and the content being on at least the front face of the cards, the cards further being configured to be flipped to selectively display the front face or the rear face;

(2) displaying on the screen of the computing device at least one card deck, the card deck comprising at least one of the cards, and the card deck and the at least one card contained therein are associated with a specific topic, at least one of the cards having content associated with the specific topic, and at least one of the cards including a question about the specific topic;

(3) displaying content on the screen configured to be viewed by the member, wherein the content presented on the card is configured to be learned by the member; and

(4) displaying at least one question on the screen configured to be viewed by the member, the question being associated with the content, and the question is configured to be answered correctly or incorrectly by the member.

Preferably, although not necessarily, the specific topic is a job skill related to a role, or position, within the organization.

Optionally, the method of training and certifying members in an organization includes the steps of: generating metric information on the member's interaction with the cards; and transmitting the metric information to the organization. The metric information is recorded and gathered by the computer program. The metric information can be selected from the group consisting of: whether a particular card was flipped; which of the cards were flipped; whether the member scrolled down through all of the content on any provided card; whether a provided hyperlink on any provided card was selected; how long the member viewed either the front face or the rear face of any provided card; and whether the member answered the question correctly.

Furthermore, the method can optionally include the steps of: analyzing the metric information by the organization to determine the member's level of mastery of the specific topic; and transmitting from the organization to the member a subsequent plurality of cards. The subsequent plurality of cards may optionally have content associated with the specific topic.

Optionally, the method of training and certifying members in an organization includes the steps of: certifying, by the organization, of the member as being proficient in the specific topic when the member correctly answers a predetermined set of questions; and compiling, by the organization, a list of the members who have been certified as being proficient in the specific topic.

Optionally, the method of training and certifying members in an organization includes the steps of: analyzing of the metric information by the organization to determine the member's level of mastery of the specific topic; and transmitting a subsequent plurality of cards from the organization to the member, the subsequent plurality of cards having content associated with the specific topic.

Optionally, the method of training and certifying members in an organization includes the step of transmitting a reward card from the organization to the member when the member is certified in the specific topic.

Optionally, the method of training and certifying members in an organization includes the steps of: (1) defining at least one card deck as a knowledge deck, wherein the cards in the knowledge deck comprise the content on the specific topic that must be mastered to achieve certification in the specific topic;

(2) removing one of the cards from the knowledge deck once the member has correctly answered a question associated with the content on that particular card, thereby establishing that the member has learned the content associated with the particular card, wherein the knowledge deck represents the content yet to be learned in order to obtain mastery in the specific topic.

Optionally, the method of training and certifying members in an organization includes the steps of: determining (or assigning), by the organization, what content is presented on each card; and determining (or assigning), by the organization, the order in which each card is presented to the member.

Optionally, the method of training and certifying members in an organization includes the steps of: certifying, by the organization, of the member as being proficient in the specific topic when the member correctly answers a predetermined set of the at least one question; and compiling, by the organization, a list of the members who have been certified as being proficient in the specific topic.

Optionally, the method of training and certifying members in an organization includes the steps of: (1) generating metric information on the member's interaction with the cards, the metric information selected from the group consisting of: whether a particular card was flipped, which of the at least one cards were flipped, whether the member scrolled down through all of the content on any provided card, whether a provided hyperlink on any provided card was selected, how long the member viewed either the front face or the rear face of any provided card, and whether the member answered the question correctly;

(2) transmitting the metric information to the organization;

(3) analyzing the metric information by the organization to determine the member's level of mastery of the specific topic; and

(4) transmitting a subsequent plurality of cards from the organization to the member, the subsequent plurality of cards having content associated with the specific topic.

Optionally, the method of training and certifying members in an organization includes the steps of: (1) analyzing the metric information by the organization to gauge the member's interest level in the specific topic; and

(2) presenting the content to the member on a subsequent plurality of cards that is associated with the specific topic when the metric information indicates that the member is both interested in, and proficient at, the specific topic; and

(3) presenting the content to the member on a subsequent plurality of cards that is associated with a second specific topic that is different from the specific topic when the metric information indicates that the member is either not interested in, or not proficient at, the specific topic.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a front view of a first embodiment of the present invention showing a card deck comprising cards shown as a graphical user interface on an electronic computing device;

FIG. 2 is a view showing a front face of an exemplary card on the left, and a rear face of the same exemplary card on the right;

FIG. 3 shows an exemplary card deck which includes a reward card;

FIG. 4 shows cards from a card deck being scrolled across the top half of the graphical user interface, and a custom card deck on the bottom half thereof, and the arrow being provided to show how a card from the card deck can be swiped into, or tucked, into the custom card deck below;

FIG. 5 is a flowchart showing a method of assigning a computer-selected tag to a card;

FIG. 6 is a schematic view showing a flowchart directed to a second embodiment of the present invention;

FIG. 7 is a flowchart showing a method for certifying members and determining what specific topics to present to a member based on that member's proficiency in learning the content on the cards already presented to him or her; and

FIG. 8 is a schematic view showing the member's electronic computing device and the second electronic device controlled by the organization, the two computing devices shown as being in electronic communication with each other.

### DETAILED DESCRIPTION OF AN EMBODIMENT OF THE INVENTION

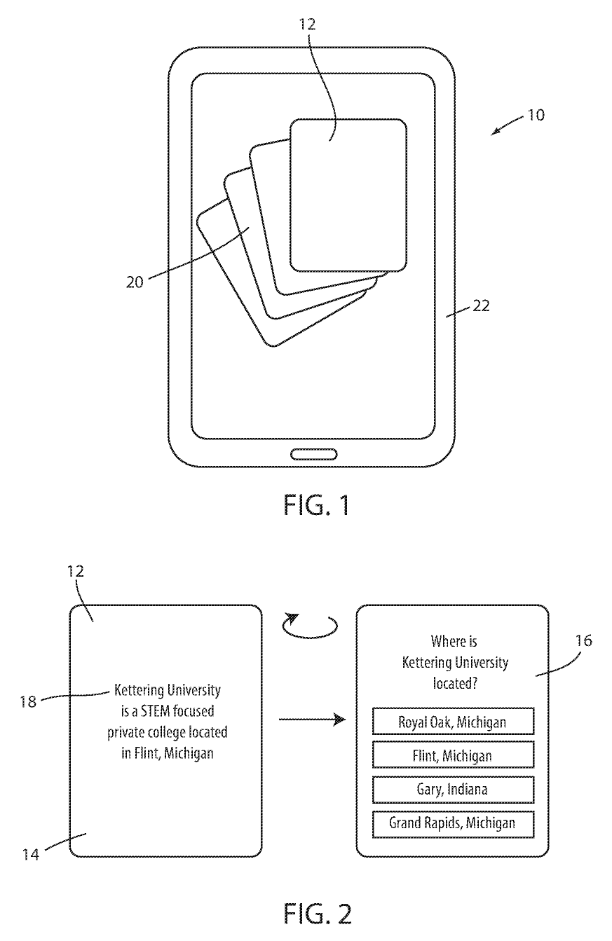

In accordance with a first embodiment of the present invention, and as shown generally in FIG. 1, there is provided a card-based system 10 for organizing and presenting content 18. The card-based system 10 comprises a plurality of cards 12 which each have a front face 14 and a rear face 16. The front face 14 of each card 12 includes user-provided content 18, and optionally, although not necessarily, the rear face 16 of each card 12 also includes user-provided content 18.

Preferably, the cards 12 exist as a dynamic graphical interface of a computer-readable software program. Similar to cards that are known to exist in a physical form in the prior art, the cards 12 described herein are displayed as two-dimensional and have a front face 14 and a rear face 16. Each card 12 is configured to be flipped to selectively display either the front face 14 or the rear face 16.

An example of the card-flipping animation in the graphical user interface is shown in U.S. Design Pat. No. D777765, the disclosure of which is hereby incorporated by reference. In addition, an example of the animation in the graphical user interface for navigating from one card in a deck to the next is shown in U.S. Design Pat. No. D777764, the disclosure of which is hereby incorporated by reference.

The user-provided content 18 can include any suitable type of content 18 that the user may wish to display. For example, the user-provided content 18 can include customized text, text gathered or compiled from an existing reference (such as a webpage on the Internet, or a book), a video, an audio recording, an image, and so forth. The user-provided content 18 can also include content 18 directly pulled from the Internet, such that the front face 14 or rear face 16 of the card 12 can include a web browser (not shown) to directly display live content 18 from the Internet. The live content 18 from the Internet could be a webpage, an image, a PDF, a video, and so on. Optionally, the user-provided content 18 can include a hyperlink to an external source, such as an Internet webpage or even an additional and separate card 12 which includes a more thorough description of the particular content 18.

The content 18 is described as being “user-provided” in this first embodiment because the user determines, or assigns, what content 18 is on each card 12. And as described in further detail below, the user also determines: (1) the subject matter (or specific content) that is associated with each card deck 20; (2) which cards 12 are in each card deck 20; as well as (3) the order of the cards 12 in the deck (or alternatively determining if the cards 12 should be ordered randomly). There is further provided a suitable user interface, such as an administrative-type setting, that permits the user to set up the content 18 for each card 12, as well as determine which cards 12 are placed in each card deck 20, and also the order of the cards 12 within the deck 20.

Turning back to the user-provided content 18, when the rear face 16 includes user-provided content 18, then the content 18 on the rear face 16 is preferably intended to test the user's retention of the user-provided content 18 on the front face 14. For example, and as shown in FIG. 2, the front face 14 might include text and a question about the content 18 thereon, and the rear face 16 will then include an opportunity for the user to answer the question. The rear face 16 can include any of the following: multiple choice options with various user-selectable answers; the option for the user to select whether a stated fact is true or false; or possibly the ability for the user to type in a free-form answer.

Alternatively, and preferably, the rear face 16 of the card 12 includes both the question and selectable options to answer the question. The card-based system 10 is preferably intended to be used with an electronic computing device 22 having a touch screen, such as a tablet or a smart phone. Therefore, it is desirable to provide a tactile user experience which allows the user to move quickly from one card 12 to the next. Preferably the question and answer are provided in the form of either a multiple-choice or true/false so the user can quickly and easily answer without having to spend any unnecessary time manually entering text.

Optionally, the user-provided content 18 on the rear face 16 is relevant to the user-provided content 18 on the front face 14. The front face 14 and rear face 16 of the card 12 may also be related to each other in which the user-provided content 18 on the front face 14 is a summary of the user-provided content 18 on the rear face 16. In this regard, the user is able to quickly review the summary on the front face 14 and either move quickly to the next card 12 if desired, or alternatively flip the card 12 to engage deeper with the content 18 on the rear face 16.

According to this first embodiment, there is also provided at least one card deck 20 which comprises at least one of the cards 12. The card deck 20 is provided to help organize the cards 12, and each card deck 20 is preferably associated with a specific topic. However, there are exceptions to this, and not necessarily every card 12 in a particular card deck 20 relates to that specific topic associated with the card deck 20. For example, and as described in greater detail below, there may also be a reward card 32 placed within the card deck 20. Optionally, each of the cards 12 is capable of simultaneously being in one or more card deck 20. Furthermore, the cards 12 are optionally capable of being added to any provided card deck 20 by a user.

There may also be at least one computer-selected tag associated with the content 18 on each of the cards 12. Another aspect of the present invention includes a method of selecting the computer-selected tag in the card-based system 10 described above. This method includes the steps of: assigning at least one computer-selected tag to the cards 12 based upon the content 18 on each respective card 12; manually reviewing the computer-selected tag by a user; and manually overwriting the computer-selected tag with a corrected tag by the user when the computer-selected tag is incorrect.

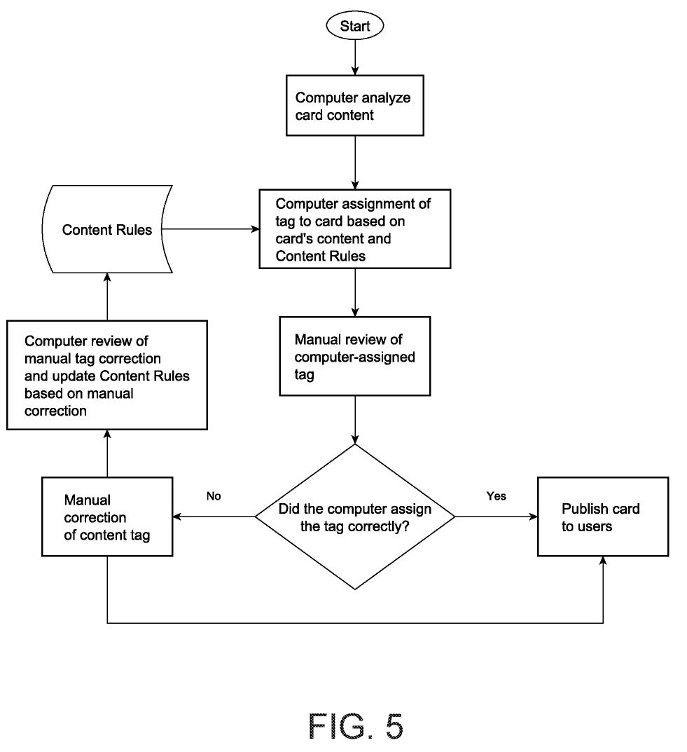

As shown in FIG. 5, the computer-selected tag is chosen by a software program having artificial intelligence. For example, a plurality of cards 12 is provided and the content 18 on the cards 12 is analyzed by the software. A tag relating to the content 18 is then assigned to the card 12 by the software program using algorithms determined by artificial intelligence. The software program having artificial intelligence can be, for example, IBM's Watson. Initially, the computer-selected tags may need to be manually-reviewed and manually-adjusted as necessary for accuracy. However, the software program will learn from those manual overrides and, in time, the software program will more accurately apply the tags. In addition, the software program will be capable of applying the tags to the cards 12 significantly faster and more accurately than if the process of tagging the content 18 was performed manually.

Optionally, this method also includes the steps of analyzing the computer-selected tag and the corrected tag by the software program; and learning how to select tags more accurately in the future based on the manually-applied corrected tag.

As discussed above, at least one tag is associated with each card 12 based upon the content 18 on the card 12. The user is then able to select various tags, and the software program will then locate all cards 12 associated with that given tag. All of those cards 12 can then be reorganized into a custom deck of cards 12 that has a default title of the searched-for term.

For example, suppose the specific topic for a card deck 20 is the various tasks that a plumber needs to know in order to become certified in his or her field. Each of the cards 12 then hypothetically contains content 18 for a specific one of those tasks. The tags associated with each card 12 could be: any one of the tools required for that task on the card 12; and the amount of time required to complete that task; the relative complexity of that task; and so on. The user could then search within this exemplary card deck 20 by selecting tags for “one hour,” “plumber's putty,” and “easy,” and the program will create a custom search card deck that includes all of the cards 12 that have been tagged with those three tags. This is a simplified example, but it is intended to help demonstrate how the computer-selected tags function and can be used to create a custom search card deck, as well as how the tags can be used as a search function.

In addition, and as shown in FIG. 4, any of the cards 12 can be tucked, or set aside for later into a custom card deck 26. Preferably, the touchscreen graphical user interface allows the user to “swipe” the card 12 downwardly from the pre-set card deck 20 into the custom card deck 26. This allows the user to easily set aside particular cards 12 for later for any purpose desired by the user.

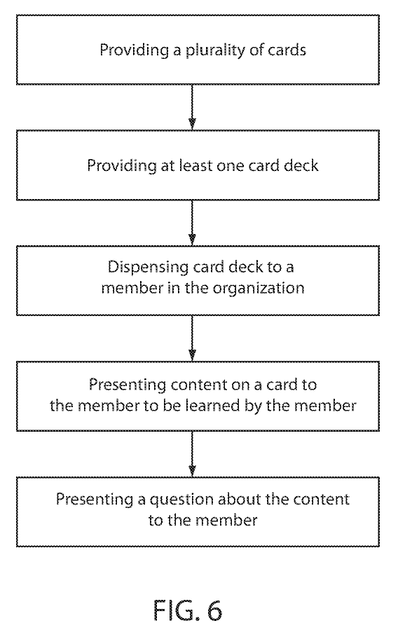

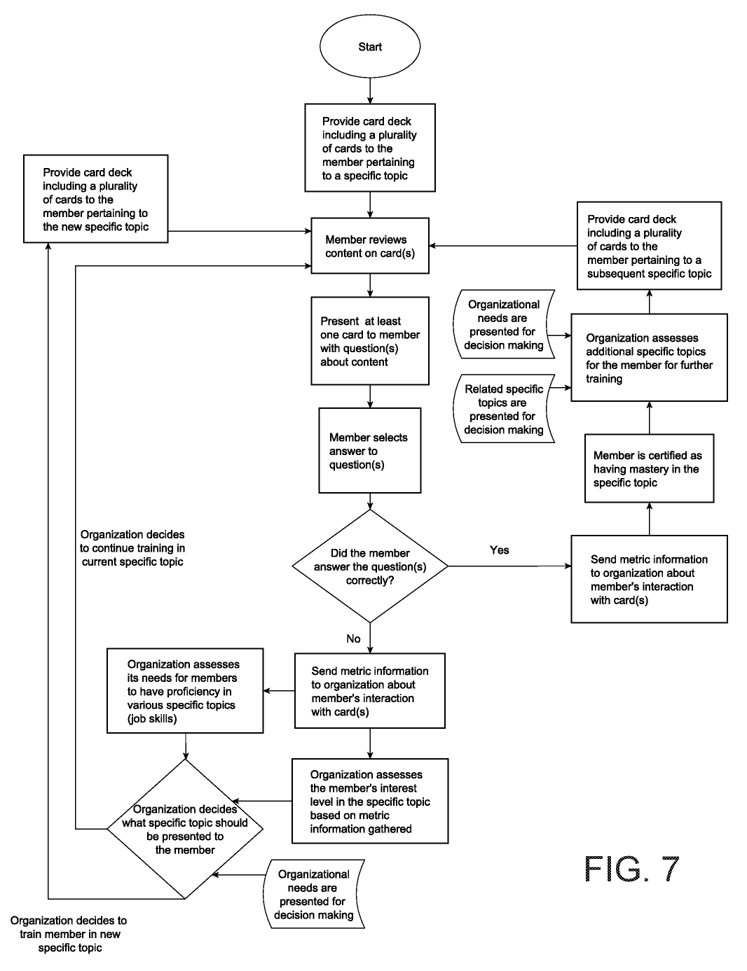

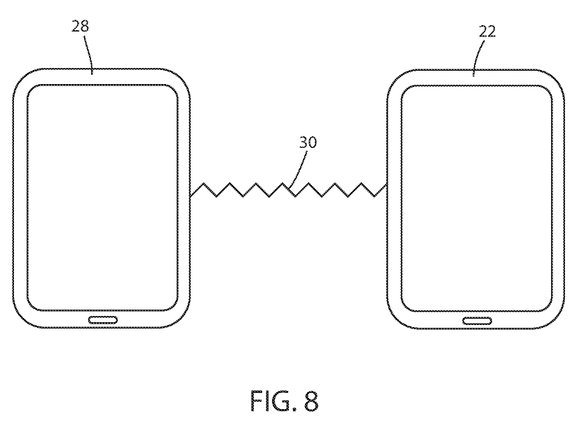

According to a second embodiment of the present invention, and as shown in FIGS. 6 and 7, there is provided a method of training and certifying members in an organization using a card-based system 10, the method includes the steps of generally: (1) providing a plurality of cards 12; (2) providing at least one card deck 20 including at least one of the cards 12; (3) dispensing the card deck 20 to at least one member in the organization; (4) presenting the content 18 on a face of the card 12 to the member such that the member attempts to learn the content 18; and (5) presenting at least one question to the member, the question being relevant to the content 18.

Preferably, the member's electronic computing device 22 operates a computer-readable software program having a graphical user interface that displays the plurality of cards 12 and the card deck 20. There is also provided a second electronic computing device 28 that is controlled, or operated by, the organization. This second electronic computing device 28 has an administrative user interface that permits the organization to place the content 18 on each card 12, as well as the questions and answers. The member's electronic computing device 22 and the second electronic computing device 28 controlled by the organization are in electronic communication to transmit and receive information with one another. This is accomplished using known communication systems 30 or technologies like WiFi, Bluetooth, a LAN, or any other suitable type of wired or wireless electronic communication network that is well-known in the art.

The method of training and certifying a user goes on to describe steps involving certifying the member as having mastery in the content 18 when the member demonstrates proficiency in answering the questions. Metric information is gathered and transmitted to the organization to inform the organization of each member's proficiency and interest level in various topics. In addition, the metric information gathered by the organization allows the organization to quickly determine which members are certified in various topics, or are close to certification in various topics. Also, the organization is capable of transmitting new card decks 20 to each member, or transmitting new cards 12 to be placed within the card decks 20 already held by each member. The metric information makes it possible for the organization to customize the content 18 being transmitted to the members based upon factors like each member's interest level and proficiency in similar topics.

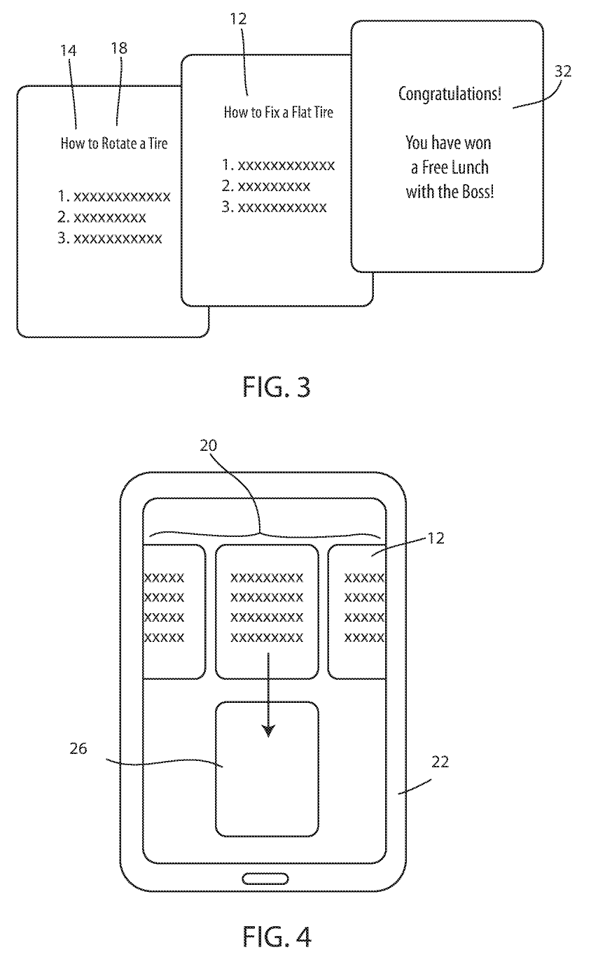

Furthermore, the organization can provide reward cards 12 to its members however it may see fit, including but not limited to, on a random basis, based upon each member's amount of interaction with the cards 12, or based upon each member's success in obtaining certification. An example of a reward card 32 in a card deck 20 is shown in FIG. 3.

As described above, the method of training and certifying members in an organization includes the step of providing a plurality of cards 12. Each card 12 is the same as that described above with respect to the first embodiment. Each card 12 has a front face 14 and a rear face 16, and the cards 12 include content 18 that is provided by the organization. The content 18 is provided on at least the front face 14 of the cards 12, and optionally on the rear face 16 of the cards 12 as well. As discussed above, the cards 12 are configured to be flipped to selectively display the front face 14 or the rear face 16. According to this embodiment, the organization determines the content 18 presented on each card 12. In addition, the organization determines the order of the cards 12 that are presented to the members in the organization.

Preferably, each card deck 20 is associated with a specific topic, and each of the cards 12 within the card deck 20 are also associated with that specific topic. However, as discussed below, there may be exceptions to this, such as a reward card 32. In addition, at least one of the cards 12 includes a question about the specific topic. Preferably, although not necessarily in the second embodiment, the specific topic is a job skill. But depending upon the nature of the organization, the specific topic could also be a classroom subject, or any other reasonable type of subject matter that is relevant to the organization for which it would like its members to be proficient.

The method of training and certifying members in an organization further includes the steps of dispensing the card deck 20 to at least one member in the organization, and then presenting the content 18 on the cards 12 to the member. As discussed above, the card deck 20 is dispensed (or transmitted) electronically through a computer network. The content 18 on the card 12 is then to be reviewed by the member, and the goal is that the member will learn and retain the content 18.

Next, the method includes the step of presenting at least one question to the member. The question is associated with the content 18 previously presented to the member, and the question is configured to be answered correctly or incorrectly by the member. As described above with respect to the first embodiment of the invention, the front face 14 of the card 12 includes content 18 about the specific topic. The questions are preferably presented on the rear face 16 of at least some of the cards 12. The questions are interactive and the member is able to touch the touchscreen to select the desired answer for the question. The software program records whether the member answered correctly or incorrectly. Depending upon the rules established by the organization for dispensing content 18 to the member, subsequent questions can be presented to the member, or alternatively the member is permitted to move on to the next card 12 in the deck.

One particular aspect of the second embodiment of the invention includes the steps of generating metric information about the member's interaction with the cards 12, and transmitting the metric information from the member's electronic computing device 22 to the organization's electronic computing device 22 so that the organization can review the metric information and make its own determinations for how to proceed.

The metric information can include any of the following, but is not limited to: (1) whether a particular card 12 was flipped; (2) which of the cards 12 were flipped; (3) whether the member scrolled down through all of the content 18 on any provided card 12 or stopped short before moving on to the next card 12; (4) whether a provided hyperlink on any provided card 12 was selected; (5) how long the member viewed either the front face 14 or the rear face 16 of any provided card 12; and (6) whether the member answered the question correctly. The metric information can then be analyzed by the organization to make any number of determinations. For example, the metric information can help the organization understand the overall effectiveness of each card 12, as well as the proficiency and interest level in the various specific topics by each member in the organization. If a particular card 12 receives a low level of interaction from a disproportionate number of the members, then that might indicate that the content 18 on that card 12 should be presented in a different manner.

According to a further aspect hereof, the organization analyzes the metric information to determine the member's level of mastery of the specific topic based upon the member's answers to each question. If a particular member shows proficiency in the specific topic, then the organization may wish to further educate this member about the specific topic so that the member can gain additional expertise in that area. Accordingly, the organization may then transmit additional cards 12 to the member which have content 18 associated with the specific topic. Alternatively, if the particular member demonstrates poor proficiency in a specific topic, then the organization may choose to transmit additional cards 12 to the member which have content 18 associated with a different specific topic, or perhaps more remedial content 18 associated with the same specific topic.

Likewise, the metric information can help tell the organization not only about each member's proficiency in a specific topic, but also each member's interest level in the specific topic based upon: (1) the time spent reviewing each card 12; (2) the number of cards 12 reviewed in that specific topic; (3) whether the member scrolled all the way to the bottom of the card 12 before moving on to the next card 12; (4) whether the member selected any hyperlinks to learn more about the content 18 on the card 12; or (5) whether the member flipped the card 12 to read further in depth about the summarized content 18 on the front face 14 of the card 12. This list is not intended to be exhaustive, and there may be additional metric information that can be gathered to help the organization gauge each member's interest level in a specific topic.

According to yet another aspect hereof, the method of training and certifying members in an organization may include the step of certifying a member of the organization as being proficient in the specific topic when the member correctly answers a predetermined set of questions. The organization can then compile a list of the members who have been certified as being proficient in the specific topic.

Likewise, the metric information will allow the organization to then determine which members have adequate qualifications for a new role or job task within the organization based upon the list of members certified within the specific topics required for that particular role. In addition, the metric information will also help the organization locate members who are not yet certified in a specific topic, but whom have shown proficiency and interest in that specific topic and would be good candidates for achieving certification. In that instance, the organization can transmit additional cards 12 related to that particular specific topic to those members so that the members can learn the content 18 on the cards 12 and complete their training to be certified in the specific topic. Therefore, it is shown that the method for training and certifying members in an organization provides a system for automatically locating qualified members for new roles. The method also automatically identifies members who have shown promising proficiency and interest to be further trained and certified for future advanced roles within the organization.

Furthermore, the software program can be used to efficiently identify and train members in an organization to fill various roles within the organization for open positions. The software program can be deployed to analyze the organization's open roles that need to be filled, identify the specific topics (or job skills) associated with the open roles, and identify members in the organization who have achieved certification in the specific topic. In addition, the software program can identify other members who have shown proficiency and interest in the specific topic, but have not yet achieved certification. In that case, it can transmit additional cards 12 to that member having content 18 on the specific topic to assist the member in achieving certification so that the member may be qualified as a candidate for the open role within the organization.

Likewise, the software program having artificial intelligence can also be used to further develop members for certification in new specific topics. Based upon the metric information, the software program can identify specific topics that are considered related to one another. For example, if a subset of members are all certified in specific topic A, specific topic B, specific topic C, and specific topic D, then the software program may determine that those four topics are related. In this example, if a member is certified in specific topic A and specific topic B, then the software program may decide to transmit cards 12 to that user having content 18 in specific topic C and/or specific topic D since the existing member base has already shown that this particular user may be particularly proficient at also obtaining certification in topics C and D.

According to yet another aspect hereof, there may be provided a card deck 20 defined as a knowledge deck which includes all of the cards 12 having content 18 on a specific topic that must be known in order to achieve certification into the specific topic. The method of training and certifying members in an organization can include the steps of: (1) defining a card deck 20 as a knowledge deck, wherein the cards 12 in the knowledge deck comprise all of the content 18 that must be learned by a member in order to be certified in the specific topic; and (2) removing one of the cards 12 from the knowledge deck once the member has correctly answered a question associated with the content 18 on that particular card 12. When the knowledge deck is used according to this method, then the knowledge deck represents the content 18 yet to be learned in order to obtain certification or mastery in the specific topic.

According to the invention described above, there is provided a card-based system which utilizes the existing advantages from physical card-based systems in the prior art, but which adds the ability to provide instant feedback on the progress and proficiency of each user (or member), allows new material (or content) to be provided to each user once the user has mastered the current set of material, and also provides real-time ability to modify and reorganize the material as needed.

It should be understood that the foregoing description is only illustrative of the aspects of the disclosed embodiments. Various alternatives and modifications can be devised by those skilled in the art without departing from the aspects of the disclosed embodiments. Accordingly, the aspects of the disclosed embodiments are intended to embrace all such alternatives, modifications, and variances that fall within the scope of the appended claims. Further, the mere fact that different features are recited in mutually different dependent or independent claims does not indicate that a combination of these features cannot be advantageously used, such as a combination remaining within the scope of the aspects of the disclosed embodiments.

What is claimed is:

1. A method of training and certifying members in an organization using a card-based system, the method including the steps of:
providing a member with a computing device operating a computer program, the computing device comprising a display screen, the computing device being configured to display on the screen a plurality of cards, each card having a front face and a rear face, the cards including content provided by the organization, and the content being on at least the front face of the cards, the cards further being configured to be flipped to selectively display the front face or the rear face;
displaying on the screen of the computing device at least one card deck, the card deck comprising at least one of the cards, and the card deck and the at least one card contained therein are associated with a specific topic, at least one of the cards having content associated with the specific topic, and at least one of the cards including a question about the specific topic;
displaying content on the screen configured to be viewed by the member, wherein the content presented on the card is configured to be learned by the member; and
displaying at least one question on the screen configured to be viewed by the member, the question being associated with the content, and the question is configured to be answered correctly or incorrectly by the member.

2. The method of claim 1 wherein the specific topic is a job skill.

3. The method of claim 2 including the steps of:
generating metric information by the computer program, the metric information including information about the member's interaction with the cards, the metric information selected from the group consisting of: whether a particular card was flipped, which of the at least one cards were flipped, whether the member scrolled down through all of the content on any provided card, whether a provided hyperlink on any provided card was selected, how long the member viewed either the front face or the rear face of any provided card, and whether the member answered the question correctly; and
transmitting the metric information to the organization.

4. The method of claim 3 including the steps of:
analyzing of the metric information by the organization to determine the member's level of mastery of the specific topic; and
transmitting a subsequent plurality of cards from the organization to the member, the subsequent plurality of cards having content associated with the specific topic.

5. The method of claim 2 including the steps of:
certifying, by the organization, of the member as being proficient in the specific topic when the member correctly answers a predetermined set of the at least one question; and
compiling, by the organization, a list of the members who have been certified as being proficient in the specific topic.

6. The method of claim 5 including the steps of:
analyzing of the metric information by the organization to determine the member's level of mastery of the specific topic; and
transmitting a subsequent plurality of cards from the organization to the member, the subsequent plurality of cards having content associated with the specific topic.

7. The method of claim 5 including the step of:
transmitting a reward card from a second computing device operated by the organization to the member's computing device when the member is certified in the specific topic.

8. The method of claim 2 including the steps of:
defining the at least one card deck as a knowledge deck, wherein the cards in the knowledge deck comprise content about the specific topic;
removing one of the cards from the knowledge deck once the member has correctly answered a question associated with the content on that particular card, wherein the knowledge deck represents the content yet to be learned in order to obtain mastery in the specific topic.

9. The method of claim 2 including the steps of:
analyzing of the metric information by the organization to determine the member's level of mastery of the specific topic; and
transmitting a subsequent plurality of cards to the member's computing device, the subsequent plurality of cards having content associated with the specific topic.

10. The method of claim 9 including the steps of:
defining the at least one card deck as a knowledge deck, wherein the cards in the knowledge deck comprise content about the specific topic;
removing one of the cards from the knowledge deck once the member has correctly answered a question associated with the content on that particular card, wherein the knowledge deck represents the content yet to be learned in order to obtain mastery in the specific topic.

11. The method of claim 1 including the steps of:
determining, by the organization, what content is presented on each provided card; and
determining, by the organization, the order in which each provided card is presented to the member.

12. The method of claim 1 including the steps of:
generating metric information by the computer program, the metric information including information about the member's interaction with the cards, the metric information selected from the group consisting of: whether a particular card was flipped, which of the at least one cards were flipped, whether the member scrolled down through all of the content on any provided card, whether a provided hyperlink on any provided card was selected, how long the member viewed either the front face or the rear face of any provided card, and whether the member answered the question correctly;
transmitting the metric information to the organization;
analyzing of the metric information by the organization to determine the member's level of mastery of the specific topic; and
transmitting a subsequent plurality of cards from the organization to the member.

13. The method of claim 1 including the steps of:
certifying, by the organization, of the member as being proficient in the specific topic when the member correctly answers a predetermined set of the at least one question; and
compiling, by the organization, a list of the members who have been certified as being proficient in the specific topic.

14. The method of claim 13 including the steps of:
generating metric information by the computer program, the metric information including information about the member's interaction with the cards, the metric information selected from the group consisting of: whether a particular card was flipped, which of the at least one cards were flipped, whether the member scrolled down through all of the content on any provided card, whether a provided hyperlink on any provided card was selected, how long the member viewed either the front face or the rear face of any provided card, and whether the member answered the question correctly;
transmitting the metric information to the organization;
analyzing of the metric information by the organization to determine the member's level of mastery of the specific topic; and
transmitting a subsequent plurality of cards from the organization to the member, the subsequent plurality of cards having content associated with the specific topic.

15. The method of claim 1 including the steps of:
generating metric information by the computer program, the metric information including information about the member's interaction with the cards, the metric information selected from the group consisting of: whether a particular card was flipped, which of the at least one cards were flipped, whether the member scrolled down through all of the content on any provided card, whether a provided hyperlink on any provided card was selected, how long the member viewed either the front face or the rear face of any provided card, and whether the member answered the question correctly; and
transmitting the metric information to the organization.

16. The method of claim 13 including the step of:
transmitting a reward card from the organization to the member when the member is certified in the specific topic.

17. The method of claim 1 including the step of:
transmitting a reward card from the organization to the member.

18. The method of claim 1 including the steps of:
defining the at least one card deck as a knowledge deck, wherein the cards in the knowledge deck comprise content about the specific topic;
removing one of the cards from the knowledge deck once the member has correctly answered a question associated with the content on that particular card, wherein the knowledge deck represents the content yet to be learned in order to obtain mastery in the specific topic.

19. The method of claim 12 wherein the subsequent plurality of cards have content associated with the specific topic.

20. The method of claim 12 including the steps of:
further analyzing of the metric information by the organization to measure the amount of time spent reviewing the content within the specific topic to gauge the member's interest level in the specific topic; and
wherein the content presented on the subsequent plurality of cards is associated with the specific topic when the metric information indicates that the member is both interested in, and proficient at, the specific topic; and
wherein the content presented on the subsequent plurality of cards is associated with a second specific topic that is different from the specific topic when the metric information indicates that the member is either not interested in, or not proficient at, the specific topic.
